(19) United States
(12) Patent Application Publication
(10) Pub. No.: US 2011/0305384 A1
(43) Pub. Date: Dec. 15, 2011

(54) INFORMATION PROCESSING APPARATUS, INFORMATION PROCESSING METHOD, AND PROGRAM

(75) Inventors: Kazumi AOYAMA, Saitama (JP); Kohtaro Sabe, Tokyo (JP)

(73) Assignee: Sony Corporation, Tokyo (JP)

(21) Appl. No.: 13/097,288

(22) Filed: Apr. 29, 2011

(30) Foreign Application Priority Data
Jun. 14, 2010 (JP) 2010-135307

(51) Int. Cl. G06K 9/62

(52) U.S. Cl. 382/159

(57) ABSTRACT

An information processing apparatus includes a first generation unit that generates learning images corresponding to a learning moving image, a first synthesis unit that generates a synthesized learning image such that a plurality of the learning images is arranged at a predetermined location and synthesized, a learning unit that computes a feature amount of the generated synthesized learning image, and performs statistical learning using the feature amount to generate a classifier, a second generation unit that generates determination images, a second synthesis unit that generates a synthesized determination image such that a plurality of the determination images is arranged at a predetermined location and synthesized, a feature amount computation unit that computes a feature amount of the generated synthesized determination image, and a determination unit that determines whether or not the determination image corresponds to a predetermined movement.

### BACKGROUND OF THE INVENTION

1. Field of the Invention

The present invention relates to an information processing apparatus, an information processing method, and a program, and particularly to an information processing apparatus, an information processing method, and a program that are designed to be able to determine a speech segment of a person that is the subject in, for example, a moving image.

2. Description of the Related Art

In the related art, there is a technique for detecting a predetermined object that is learned in advance from a still image, and for example, according to Japanese Unexamined Patent Application Publication No. 2005-284348, the face of a person can be detected from a still image. More specifically, a plurality of two-pixel combinations are set in a still image as a feature amount of an object (in this case, a person's face), and a difference of values (luminance values) of two pixels in each combination is calculated, thereby determining the presence of the object that has been learned based on the feature amount. The feature amount is referred to as a PixDif feature amount, and also hereinbelow as a pixel difference feature amount.

In addition, in the related art, there is a technique for discriminating movements of a subject in a moving image, and for example, according to Japanese Unexamined Patent Application Publication No. 2009-223761, a speech segment indicating a period in which a person, the subject of a moving image, is speaking can be determined. More specifically, differences between values of all pixels in the adjacent two frames in a moving image are calculated, and a speech segment is detected based on the calculation result.

### SUMMARY OF THE INVENTION

The pixel difference feature amount described in Japanese Unexamined Patent Application Publication No. 2005-284348 can calculate feature amounts with a relatively small calculation cost, and relatively high accuracy can be attained in the detection of an object using the feature amount. However, the pixel difference feature amount indicates a feature amount in a still image, so could not be used as a time-series feature amount in a case, such as, of discriminating a speech segment of a person in a moving image.

According to the invention described in Japanese Unexamined Patent Application Publication No. 2009-223761, a speech segment of a person in a moving image can be discriminated. However, the invention only pays attention to the relationship between the adjacent two frames, and it is difficult to raise the discrimination accuracy. In addition, since the differences between all the pixel values in two frames are to be calculated, the calculation amount is relatively large. Thus, when there is a plurality of persons in an image and a speech segment of each person is to be detected, it is difficult to perform a real-time process.

The present invention takes the above circumstances into consideration, and it is desirable to discriminate movement segments where a subject in a moving image shows movement with high accuracy and swiftness.

According to an embodiment of the present invention, there is provided an information processing apparatus including first generating means for generating learning images respectively corresponding to each frame of a learning moving image in which a subject conducting a predetermined movement is imaged, first synthesizing means for synthesizing a synthesized learning image such that one of the sequentially generated learning images is set to serve as a reference, a plurality of the learning images corresponding to the predetermined number of frames including the learning image serving as the reference is arranged at a predetermined location and synthesized, learning means for computing a feature amount of the generated synthesized learning image, and performing statistical learning using the feature amount obtained as the computation result to generate a classifier that discriminates whether or not an determination image that serves as a reference of an input synthesized determination image corresponds to the predetermined movement, second generating means for generating determination images respectively corresponding to each frame of a determination moving image to be determined whether or not the image corresponds to the predetermined movement, second synthesizing means for generating a synthesized determination image such that one of the sequentially generated determination images is set to serve as a reference, and a plurality of the determination images corresponding to a predetermined number of frames including the determination image serving as the reference is arranged at a predetermined location and synthesized, feature amount computing means for computing a feature amount of the generated synthesized determination image, and determining means for determining whether or not the determination image serving as the reference for the synthesized determination image corresponds to the predetermined movement based on a score as a discrimination result obtained by inputting the computed feature amount to the classifier.

The feature amount of an image may be a pixel difference feature amount.

According to the embodiment of the invention, the information processing apparatus further includes normalizing means for normalizing a score as a discrimination result obtained by inputting the computed feature amount to the classifier, and the determining means may determine whether or not the determination image serving as the reference for the synthesized determination image corresponds to the predetermined movement based on the normalized score.

The predetermined movement may be speech of a person who is a subject, and the determining means may determine whether or not the determination image serving as the reference for the synthesized determination image corresponds to a speech segment based on a score as a discrimination result obtained by inputting the computed feature amount to the classifier.

The first generating means may detect the face area of a person from each frame of the learning moving image in which the person speaking is imaged as a subject, detect the lip area from the detected face area, and generate a lip image as the learning image based on the detected lip area, and the second generating means may detect the face area of a person from each frame of the determination moving image, detect the lip area from the detected face area, and generate a lip image as the determination image based on the detected lip area.

When the face area is not detected from a frame to be processed in the determination moving image, the second generating means may generate the lip image as the determination image based on location information on a face area detected in the previous frame.

The predetermined movement may be speech of a person who is a subject, and the determining means may determine speech content corresponding to the determination image serving as the reference for the synthesized determination image based on a score as a discrimination result obtained by inputting the computed feature amount to the classifier.

According to another embodiment of the invention, there is provided an information processing method performed by an information processing apparatus identifying an input moving image, which includes the steps of firstly generating learning images respectively corresponding to each frame of a learning moving image in which a subject conducting a predetermined movement is imaged, firstly synthesizing to generate a synthesized learning image such that one of the sequentially generated learning images is set to serve as a reference, a plurality of the learning images corresponding to the predetermined number of frames including the learning image serving as the reference is arranged at a predetermined location and synthesized, learning to compute a feature amount of the generated synthesized learning image, and perform statistical learning using the feature amount obtained as the computation result so as to generate a classifier that discriminates whether or not an determination image that serves as a reference of an input synthesized determination image corresponds to the predetermined movement, secondly generating determination images respectively corresponding to each frame of a determination moving image to be determined whether or not the image corresponds to the predetermined movement, secondly synthesizing to generate a synthesized determination image such that one of the sequentially generated determination images is set to serve as a reference, and a plurality of the determination images corresponding to a predetermined number of frames including the determination image serving as the reference is arranged at a predetermined location and synthesized, computing a feature amount of the generated synthesized determination image, and determining whether or not the determination image serving as the reference for the synthesized determination image corresponds to the predetermined movement based on a score as a discrimination result obtained by inputting the computed feature amount to the classifier.

According to still another embodiment of the invention, there is provided a program which causes a computer to function as first generating means for generating learning images respectively corresponding to each frame of a learning moving image in which a subject conducting a predetermined movement is imaged, first synthesizing means for generating a synthesized learning image such that one of the sequentially generated learning images is set to serve as a reference, a plurality of the learning images corresponding to the predetermined number of frames including the learning image serving as the reference is arranged at a predetermined location and synthesized, learning means for computing a feature amount of the generated synthesized learning image, and performing statistical learning using the feature amount obtained as the computation result to generate a classifier that discriminates whether or not an determination image that serves as a reference of an input synthesized determination image corresponds to the predetermined movement, second generating means for generating determination images respectively corresponding to each frame of a determination moving image to be determined whether or not the image corresponds to the predetermined movement, second synthesizing means for generating a synthesized determination image such that one of the sequentially generated determination images is set to serve as a reference, and a plurality of the determination images corresponding to a predetermined number of frames including the determination image serving as the reference is arranged at a predetermined location and synthesized, feature amount computing means for computing a feature amount of the generated synthesized determination image, and determining means for determining whether or not the determination image serving as the reference for the synthesized determination image corresponds to the predetermined movement based on a score as a discrimination result obtained by inputting the computed feature amount to the classifier.

According to the embodiments of the invention, learning images respectively corresponding to each frame of a learning moving image in which a subject conducting a predetermined movement is imaged are generated, a synthesized learning image is generated such that one of the sequentially generated learning images is set to serve as a reference, a plurality of the learning images corresponding to the predetermined number of frames including the learning image serving as the reference is arranged at a predetermined location and synthesized, and a classifier that discriminates whether or not an determination image that serves as a reference of an input synthesized determination image corresponds to the predetermined movement is generated by computing a feature amount of the generated synthesized learning image and performing statistical learning using the feature amount obtained as the computation result. Furthermore, determination images respectively corresponding to each frame of a determination moving image to be determined whether or not the image corresponds to the predetermined movement are generated, a synthesized determination image is generated such that one of the sequentially generated determination images is set to serve as a reference, and a plurality of the determination images corresponding to a predetermined number of frames including the determination image serving as the reference is arranged at a predetermined location and synthesized, a feature amount of the generated synthesized determination image is computed, and it is determined whether or not the determination image serving as the reference for the synthesized determination image corresponds to the predetermined movement based on a score as a discrimination result obtained by inputting the computed feature amount to the classifier.

According to an embodiment of the invention, it is possible to swiftly and highly accurately discriminate movement segments where a subject in a moving image shows movement.

### BRIEF DESCRIPTION OF THE DRAWINGS

FIG. 1 is a block diagram showing a configuration example of a learning device to which an embodiment of the invention is applied;

FIGS. 2A to 2C are diagrams showing examples of a face image, a lip area, and a lip image;

FIGS. 3A and 3B are diagrams showing a lip image and a time-series synthesized image;

FIG. 4 is a flowchart illustrating a speech segment classifier learning process;

FIG. 5 is a block diagram showing a configuration example of a speech segment determining device to which an embodiment of the invention is applied;

FIG. 6 is a graph for illustrating the normalization of speech scores;

FIG. 7 is a graph for illustrating the normalization of speech scores;

FIG. 8 is a diagram for illustrating interpolation of normalized scores;

FIG. 9 is a flowchart illustrating a speech segment determination process;

FIG. 10 is a flowchart illustrating a tracking process;

FIG. 11 is a graph showing the difference in determination performances based on 2N+1, the number of face image frames that are the base of a time-series synthesized image;

FIG. 12 is a graph showing the determination performance of a speech segment determining device used in speech segments;

FIG. 13 is a graph showing performances in the application to speech recognition; and

FIG. 14 is a block diagram showing a configuration example of a computer.

### DESCRIPTION OF THE PREFERRED EMBODIMENTS

Hereinbelow, an exemplary embodiment of the present invention (hereinafter, referred to as an “embodiment”) will be described in detail with reference to drawings.

### 1. Embodiment

### [Configuration Example of Learning Device]

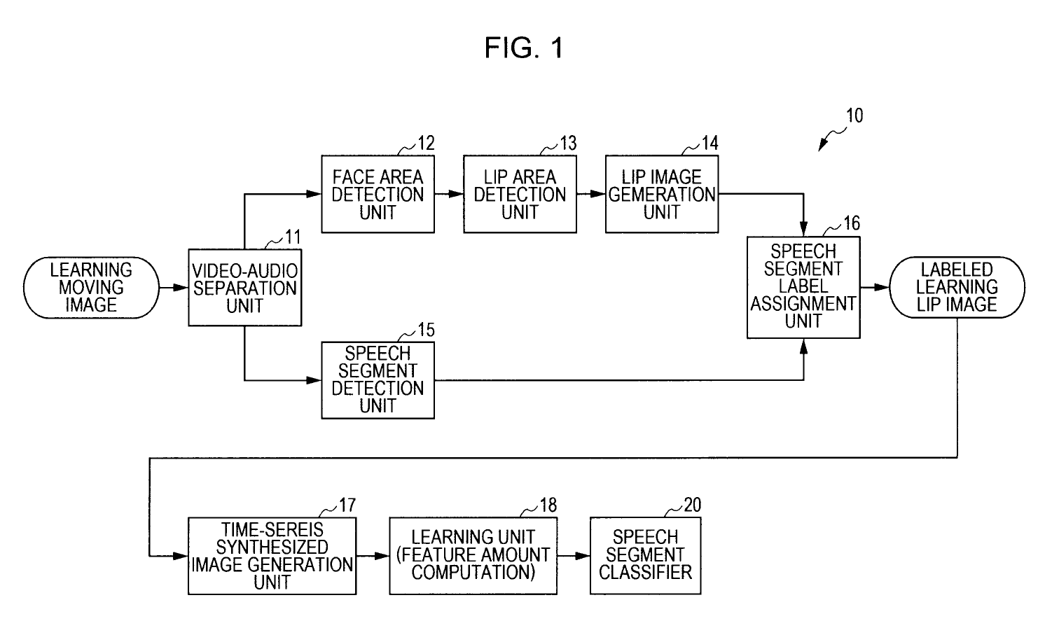

FIG. 1 is a block diagram showing a configuration example of a learning device which is an embodiment of the invention. The learning device 10 is for learning a speech segment classifier 20 used in a speech segment determining device 30 to be described later. Furthermore, the learning device 10 may be integrally combined with the speech segment determining device 30.

The learning device 10 is composed of a video-audio separation unit 11, a face area detection unit 12, a lip area detection unit 13, a lip image generation unit 14, a speech segment detection unit 15, a speech segment label assignment unit 16, a time-series synthesized image generation unit 17, and a learning unit 18.

The video-audio separation unit 11 is input with a moving image with voice for learning (hereinafter, referred to as a learning moving image) obtained by capturing a state where a person of a subject is speaking, or on the contrary is silent, and separates the image into learning video signals and learning audio signals. The separated learning video signals are input to the face area detection unit 12, and the separated learning audio signals are input to the speech segment detection unit 15.

Furthermore, a learning moving image may be prepared by conducting video photographing for the purpose of learning, and for example, content such as a television program may be used.

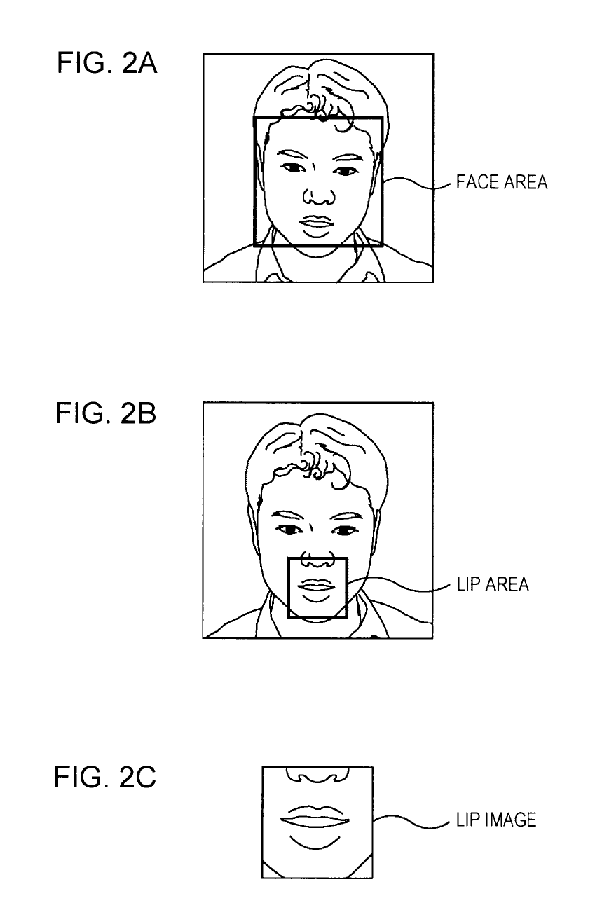

The face area detection unit 12 detects and extracts a face area that contains the face of a person from each frame of the video signals separated from the learning moving image as shown in FIG. 2A, and outputs the extracted face area to the lip area detection unit 13.

The lip area detection unit 13 detects and extracts a lip area that contains end points of mouth angles of a lip from the face area of each frame input from the face area detection unit 12, as shown in FIG. 2B, and outputs the extracted lip area to the lip image generation unit 14.

Furthermore, the detection method of the face and lip areas can be applied with any existing method such as the method disclosed in, for example, Japanese Unexamined Patent Application Publication No. 2005-284487, or the like.

The lip image generation unit 14 appropriately performs rotation correction for the lip area of each frame input from the lip area detection unit 13 so that a line connecting the end points of the mouth angles of the lip is horizontal as shown in FIG. 2C. Furthermore, the lip image generation unit 14 generates a lip image of which pixels have luminance values and output the image to the speech segment label assignment unit 16 by enlarging or reducing the lip area that has been subjected to the rotation correction to a predetermined size (for example, 32×32 pixels) and converting the part to monotone.

The speech segment detection unit 15 compares a voice level of the learning video signals separated from the learning moving image to a predetermined threshold value to discriminate whether the voice corresponds to a speech segment where a person of a subject in the learning moving image is speaking, or to a non-speech segment where the person is not speaking, and outputs the discrimination result to the speech segment label assignment unit 16.

The speech segment label assignment unit 16 assigns a speech segment label indicating whether the lip image is of a speech segment or a non-speech segment to the lip image of each frame based on the discrimination result by the speech segment detection unit 15. Then, the labeled learning lip images obtained from the result are sequentially output to the time-series synthesized image generation unit 17.

The time-series synthesized image generation unit 17 includes a memory inside for storing several frames of labeled lip learning images, and subsequently pays attention to each labeled lip learning image corresponding to each frame of the learning video signals input sequentially. Furthermore, the time-series synthesized image generation unit 17 generates one synthesized image by arranging a total of 2N+1 labeled learning lip images, which are composed of N frames respectively positioned on the front and back of the reference of a labeled learning lip image t to which attention is paid, to a predetermined location. Since the one generated synthesized image is composed of labeled learning lip images for 2N+1 frames, in other words, labeled learning lip images in time series, the synthesized images will be referred to as a time-series synthesized image hereinbelow. Furthermore, N is an integer equal to or higher than 0, but the preferable value is around 2 (of which detailed description will be provided later).

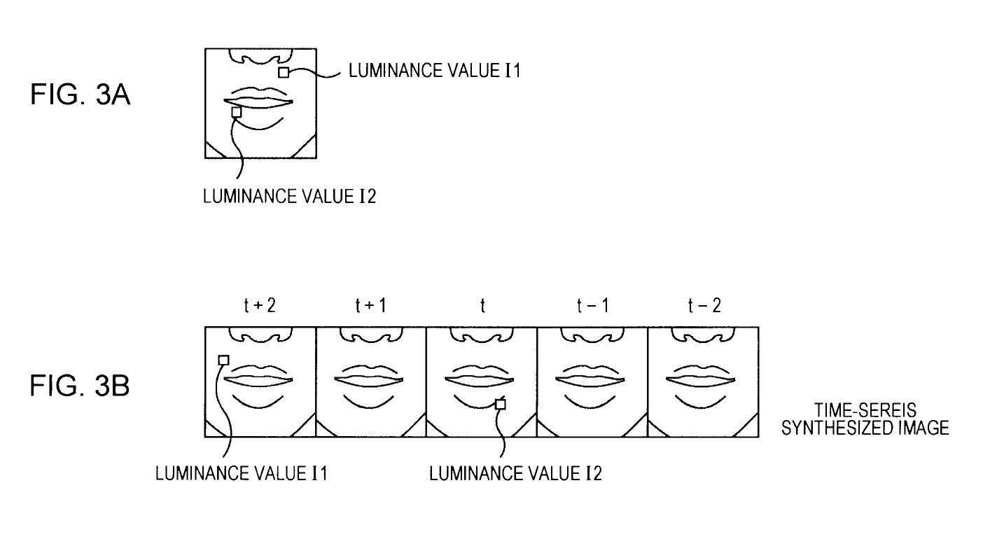

FIG. 3B shows a time-series synthesized image composed of five labeled learning lip images, which are t+2, t+1, t, t−1, and t−2, corresponding to the case where N=2. The arrangement of the five labeled learning lip images in the generation of a time-series synthesized image is not limited to that shown in FIG. 3B, and may be arbitrarily set.

Hereinbelow, among time-series synthesized images generated by the time-series synthesized image generation unit 17, when all 2N+1 labeled learning lip images which serve as the base correspond to a speech segment, a time-series synthesized image is referred to as positive data, and when all 2N+1 labeled learning lip images which serve as the base correspond to a non-speech segment, a time-series synthesized image is referred to as negative data.

The time-series synthesized image generation unit 17 is designed to supply positive data and negative data to the learning unit 18. In other words, a time-series synthesized image that is not associated with either positive data or negative data (a synthesized image including a labeled lip image corresponding to the boundary between a speech segment and a non-speech segment) is not used for learning.

The learning unit 18 has a labeled time-series synthesized image (positive data and negative data) supplied from the time-series synthesized image generation unit 17 as the base to compute a pixel difference feature amount thereof.

Herein, a process of computing a pixel difference feature amount of the time-series synthesized image in the learning unit 18 will be described with reference to FIGS. 3A and 3B.

FIG. 3A shows computation of a pixel difference feature amount that is an existing feature amount, and FIG. 3B shows computation of a pixel difference feature amount of the time-series synthesized image in the learning unit 18. A pixel difference feature amount is obtained by calculating the difference between values of two pixels (luminance values) I1 and I2 (I1−I2) on pixels.

In other words, in the computation process shown in FIGS. 3A and 3B, a plurality of two-pixel combinations is set in a still image, and the difference of values of two pixels (luminance values) in each combination I1 and I2 (I1−I2) is calculated, and thus there is no difference in the computing method in both drawings. Therefore, when a pixel difference feature amount of a time-series synthesized image is to be calculated, it is possible to use an existing program for computation or the like as is.

Furthermore, as shown in FIG. 3B, since the pixel difference feature amount is calculated in the learning unit 18 from a time-series synthesized image that is a still image and image information in time series, characteristics of obtained pixel difference feature amount in times series are shown.

The speech segment classifier 20 is composed of a plurality of binary weak classifiers h(x). The plurality of binary weak classifiers h(x) corresponds respectively to two-pixel combinations on a time-series synthesized image, and in each binary weak classifier h(x), discrimination is performed such that affirmative (+1) indicates a speech segment or negative (−1) indicates a non-speech segment according to a comparison result of a pixel difference feature amount (I1−I2) and a threshold value Th of each combination, as shown in the following formula (1).

h(x)=−1, if I1−I2≦Th

h(x)=+1, if I1−I2>Th (1)

Furthermore, the learning unit 18 generates the speech segment classifier 20 by having a plurality of two-pixel combinations and the threshold Th thereof as parameters of each binary weak classifier and selecting the optimum one out of the parameters by boosting learning.

### [Operation of Learning Device 10]

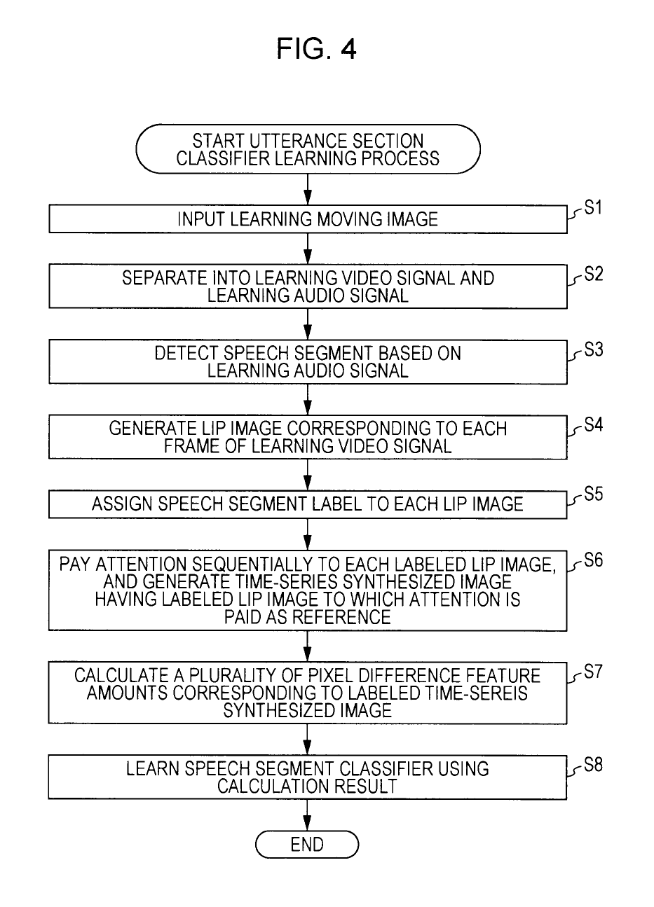

Next, the operation of the learning device 10 will be described. FIG. 4 is a flowchart illustrating a speech segment classifier learning process by the learning device 10.

In Step S1, a learning moving image is input to the video-audio separation unit 11. In Step S2, the video-audio separation unit 11 separates the input learning moving image into learning video signals and learning audio signals, and inputs the learning video signals to the face area detection unit 12 and the learning audio signals to the speech segment detection unit 15.

In Step S3, the speech segment detection unit 15 discriminates whether voice in the learning moving image corresponds to a speech segment or a non-speech segment by comparing the voice level of the learning audio signals to a predetermined threshold value, and outputs the discrimination result to the speech segment label assignment unit 16.

In Step S4, the face area detection unit 12 extracts the face area from each frame of the learning video signals and outputs the data to the lip area detection unit 13. The lip area detection unit 13 extracts the lip area from the face area of each frame and output the data to the lip image generation unit 14. The lip image generation unit 14 generates lip images based on the lip area of each frame and outputs the images to the speech segment label assignment unit 16.

Furthermore, the process of Step S3 and the process of Step S4 are executed in parallel in practice.

In Step S5, the speech segment label assignment unit 16 generates labeled lip learning images by assigning speech segment labels to the lip images corresponding to each frame based on the discrimination result of the speech segment detection unit 15, and sequentially outputs the labeled lip learning images to the time-series synthesized image generation unit 17.

In Step S6, the time-series synthesized image generation unit 17 sequentially pays attention to the labeled learning lip images corresponding to each frame, generates a time-series synthesized image with the reference of a labeled learning lip image t to which attention is paid, and supplies positive data and negative data in the time-series synthesized image to the learning unit 18.

In Step S7, the learning unit 18 computes pixel difference feature amounts for the positive data and the negative data input from the time-series synthesized image generation unit 17. Moreover, in Step S8, the learning unit 18 learns (generates) the speech segment classifier 20 by having a plurality of two-pixel combinations and the threshold Th thereof in the computation of the pixel difference feature amount as parameters of each binary weak classifier and selecting the optimum one out of the parameters by boosting learning. Then, the speech segment classifier learning process ends. The generated speech segment classifier 20 herein is used in a speech segment determining device 30 to be described later.

### [Configuration Example of Speech Segment Determining Device]

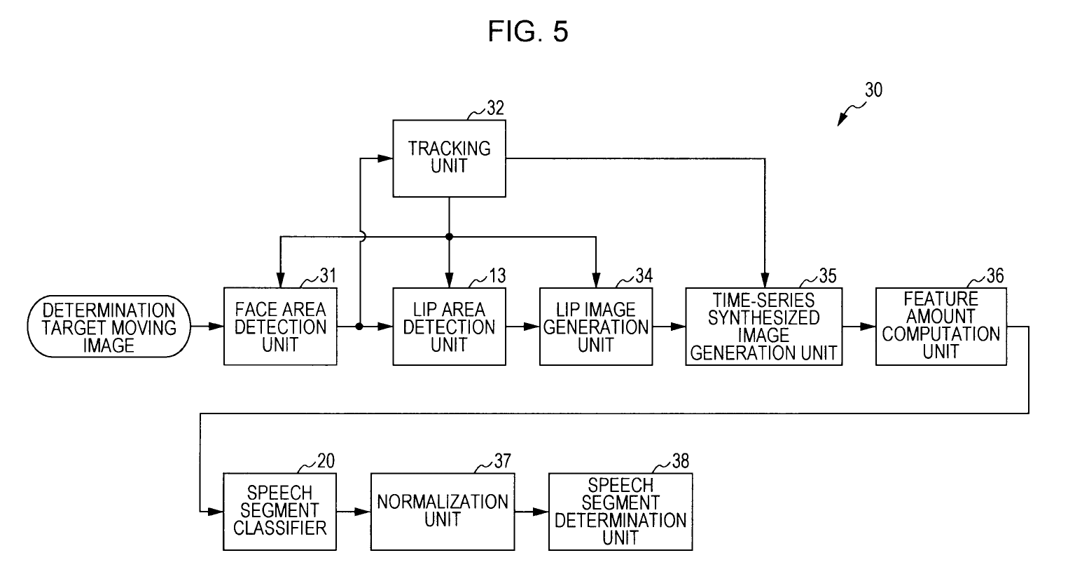

FIG. 5 shows a configuration example of the speech segment determining device that is an embodiment of the invention. The speech segment determining device 30 uses the speech segment classifier 20 learned by the learning device 10, and determines a speech segment of a person that is the subject of a moving image to be processed (hereinafter, referred to as a determination target moving image). Furthermore, the speech segment determining device 30 may be integrally combined with the learning device 10.

The speech segment determining device 30 is composed of a face area detection unit 31, a tracking unit 32, a lip area detection unit 33, a lip image generation unit 34, a time-series synthesized image generation unit 35, a feature amount computation unit 36, a normalization unit 37, and a speech segment determination unit 38 in addition to the speech segment classifier 20.

The face area detection unit 31 detects a face area that includes the face of a person from each frame of the determination target moving image in the same manner as the face area detection unit 12 of FIG. 1, and informs the tracking unit 32 of coordinate information thereof. When there is a plurality of face areas of persons in one frame of the determination target moving image, each of the areas is detected. In addition, the face area detection unit 31 extracts the detected face area and outputs the data to the lip area detection unit 33. Furthermore, when the tracking unit 32 informs information on a location to be extracted as a face area, the face area detection unit 31 extracts the face area based on the information and outputs the data to the lip image generation unit 34.

The tracking unit 32 manages a tracking ID list, assigns a tracking ID to each face area detected by the face area detection unit 31, and records the data in the tracking ID list or updates the list by making the data correspond to the location information. In addition, when the face area detection unit 31 fails to detect the face area of a person from the frames of the determination target moving image, the tracking unit 32 informs the face area detection unit 31, the lip area detection unit 33, and the lip image generation unit 34 of location information that is assumed to be of a face area, a lip area, and a lip image.

In the same manner as the lip area detection unit 13 of FIG. 1, the lip area detection unit 33 detects and extracts a lip area that includes end points of mouth angles of a lip from the face area of each frame input from the face area detection unit 31, and outputs the extracted lip area to the lip image generation unit 34. Furthermore, when location information to be extracted as the lip area is informed from the tracking unit 32, the lip area detection unit 33 extracts the lip area according to the information and outputs the data to the lip image generation unit 34.

The lip image generation unit 34 appropriately performs rotation correction for the lip area of each frame input from the lip area detection unit 33 so that a line connecting the end points of mouth angles of the lip is horizontal, in the same manner as the lip image generation unit 14 of FIG. 1. Furthermore, the lip image generation unit 34 generates a lip image of which pixels have luminance values and outputs the image to the time-series synthesized image generation unit 35 by enlarging or reducing the lip area that has been subjected to the rotation correction to a predetermined size (for example, 32×32 pixels) and converting the part to monotone. Moreover, when information on a location to be extracted as a lip image is informed from the tracking unit 32, the lip image generation unit 34 generates a lip image according to the information and outputs the data to the time-series synthesized image generation unit 35. Furthermore, when a plurality of face areas of persons is detected from one frame of the determination target moving image, in other words, when face areas assigned with different tracking IDs are detected, lip images corresponding to each of the tracking IDs are generated. Hereinbelow, a lip image output from the lip image generation unit 34 to the time-series synthesized image generation unit 35 is referred to as a determination target lip image.

The time-series synthesized image generation unit 35 includes a memory inside to store several frames of the determination target lip image, and sequentially pays attention to the determination target lip image of each frame for every tracking ID, in the same manner as the time-series synthesized image generation unit 17 of FIG. 1. Furthermore, the time-series synthesized image generation unit 35 generates time-series synthesized images by synthesizing a total of 2N+1 determination target lip images that are composed of N frames respectively positioned on the front and back of the reference of a determination target lip image t to which attention is paid. Herein, the value of N and the arrangement of each determination target lip image are assumed to be the same as the time-series synthesized image generated by the time-series synthesized image generation unit 17 of FIG. 1. Furthermore, the time-series synthesized image generation unit 35 outputs the time-series synthesized images sequentially generated corresponding to each tracking ID to the feature amount computation unit 36.

The feature amount computation unit 36 computes pixel difference feature amounts for the time-series synthesized images that are supplied from the time-series synthesized image generation unit 35 and correspond to each tracking ID, and outputs the computation result to the speech segment classifier 20. Furthermore, two-pixel combinations in the computation of a pixel difference feature amount may only correspond respectively to a plurality of binary weak classifiers composing the speech segment classifier 20. In other words, feature amount computation unit 36 computes the same number of pixel difference feature amounts as the number of binary weak classifiers composing the speech segment classifier 20, based on each time-series synthesized image.

The speech segment classifier 20 inputs the pixel difference feature amounts corresponding to the time-series synthesized images of each of the tracking IDs input from the feature amount computation unit 36 to the corresponding binary weak classifiers, and obtains the determination result (affirmative (+1) or negative (−1)). Furthermore, the speech segment classifier 20 multiplies the discrimination result of each of the binary weak classifier by a weighted coefficient according to the reliability of the result, performs weighted addition thereto, then computes a speech score indicating whether the determination target lip image that becomes the reference of the time-series synthesized image corresponds to a speech segment or a non-speech segment, and outputs the result to the normalization unit 37.

The normalization unit 37 normalizes the speech score input from the speech segment classifier 20 to a value that is equal to or higher than 0 and equal to or lower than 1, and outputs the result to the speech segment determination unit 38.

Furthermore, the following inconvenience can be suppressed by providing the normalization unit 37. In other words, when the speech score output from the speech segment classifier 20 is changed by adding positive data or negative data thereto based on the learning moving image used when the speech segment classifier 20 is learned, the score has differing values for the same determination target moving image. Therefore, since the maximum value and the minimum value of the speech score change, in the latter part, it is inconvenient that it is necessary for the threshold value to be compared to the speech score in the speech segment determination unit 38 also to be changed accordingly.

However, since the maximum value of the speech score input to the speech segment determination unit 38 is fixed to 1 and the minimum value to 0 by providing the normalization unit 37, the threshold value to be compared to the speech score can also be fixed.

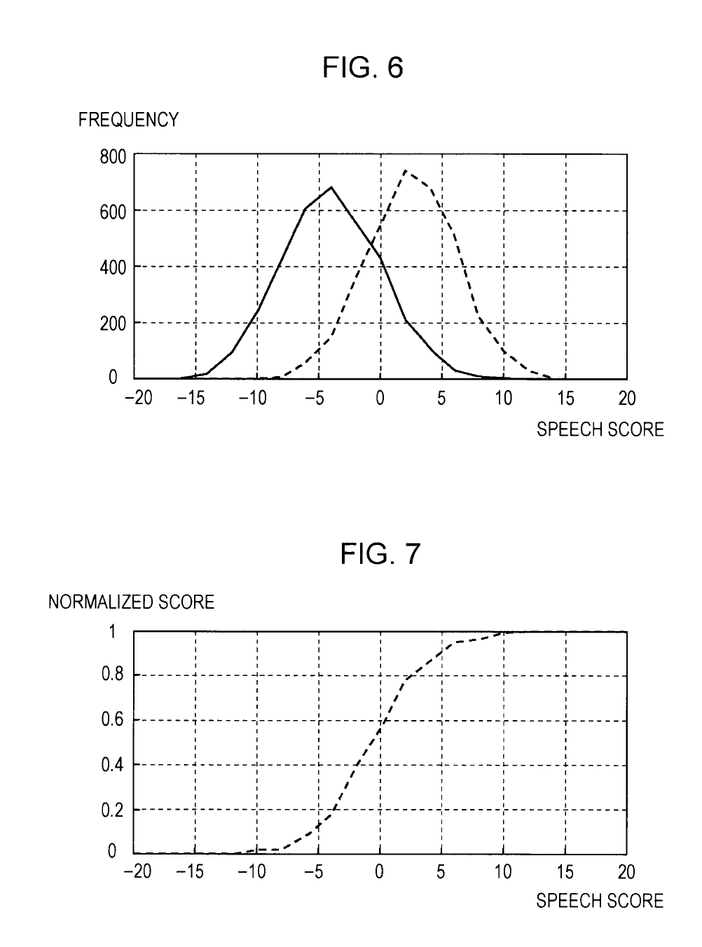

Herein, the normalization of the speech score by the normalization unit 37 will be described in detail with reference to FIGS. 6 to 8.

First, a plurality of positive data pieces and negative data pieces different from those used in the learning of the speech segment classifier 20 is prepared. Then, the data pieces are input to the speech segment classifier 20 to acquire speech scores, and a frequency distribution of the speech scores corresponding to each of the positive data pieces and the negative data pieces is created as shown in FIG. 6. In FIG. 6, the horizontal axis represents speech scores, the vertical axis represents frequencies, the broken line corresponds to positive data, and the solid line to negative data.

Next, sampling points are set at a predetermined interval on the speech scores of the horizontal axis, and the frequency corresponding to the positive data is divided by an addition of the frequency corresponding to the positive data to the frequency corresponding to the negative data to calculate a normalized speech score (hereinbelow, referred to also as a normalized score) according to the following formula (2) for each sampling point.

Normalized Score=Frequency corresponding to Positive Data/(Frequency corresponding to Positive Data+Frequency corresponding to Negative Data) (2)

Accordingly, a normalized score at a sampling point of a speech score can be obtained. FIG. 7 shows the correspondence relationship between a speech score and a normalized score. Furthermore, in the drawing, the horizontal axis represents speech scores, and the vertical axis represents normalized scores.

The normalization unit 37 retains the correspondence relationship between the speech scores and the normalized scores as shown in FIG. 7, and the speech scores input according to the data are converted to the normalized scores.

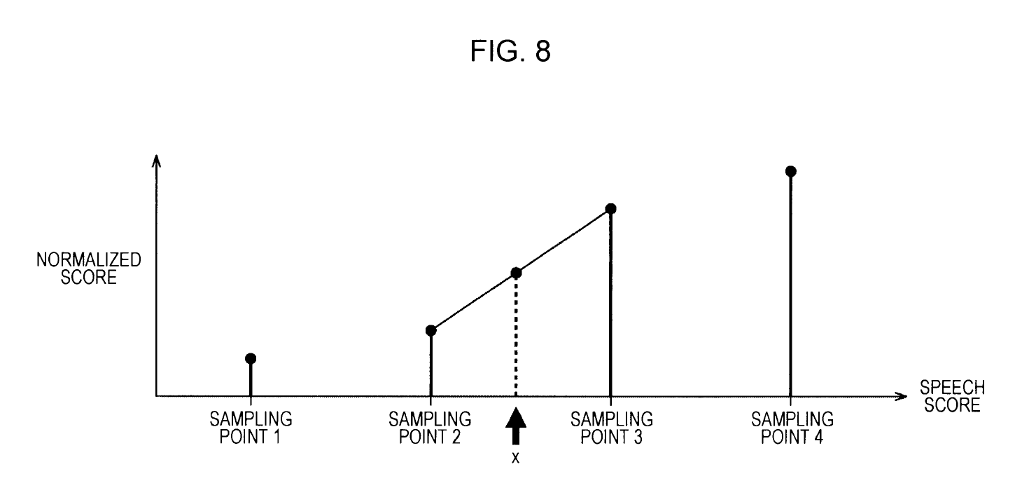

Furthermore, the correspondence relationship between the speech scores and the normalized scores may be retained as a table or a function. When it is retained as a table, the normalized scores corresponding to sampling points of the speech scores are retained only for the points, as shown in FIG. 8, for example. In addition, a normalized score that corresponds to a value between sampling points of speech scores and is not retained is obtained by performing linear interpolation for a normalized score corresponding to a sampling point of a speech score.

Returning to FIG. 5, the speech segment determination unit 38 determines whether a determination target lip image corresponding to a normalized score corresponds to a speech segment or to a non-speech segment by comparing the normalized score input from the normalization unit 37 to a predetermined threshold value. Furthermore, the determination result may not be output in the unit of one frame, but the determination result in the unit of one frame may be retained as many as several frames and averaged, and the determination result may be output in the unit of several frames.

### [Operation of Speech Segment Determining Device 30]

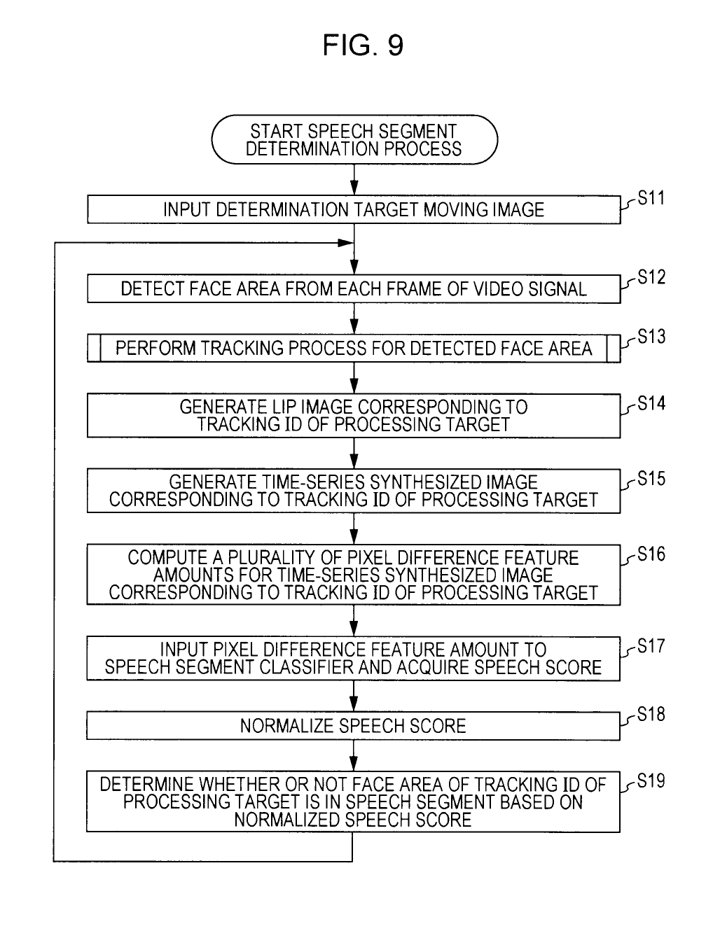

Next, the operation of the speech segment determining device 30 will be described. FIG. 9 is a flowchart illustrating a speech segment determination process by the speech segment determining device 30.

In Step S11, a determination target moving image is input to the face area detection unit 31. In Step S12, the face area detection unit 31 detects a face area that includes the face of a person from each frame of the determination target moving image, and informs the tracking unit 32 of coordinate information thereof. Furthermore, when there is a plurality of face areas of persons in one frame of the determination target moving image, each of the areas is detected.

In Step S13, the tracking unit 32 performs a tracking process for each face area detected by the face area detection unit 31. The tracking process will be described in detail.

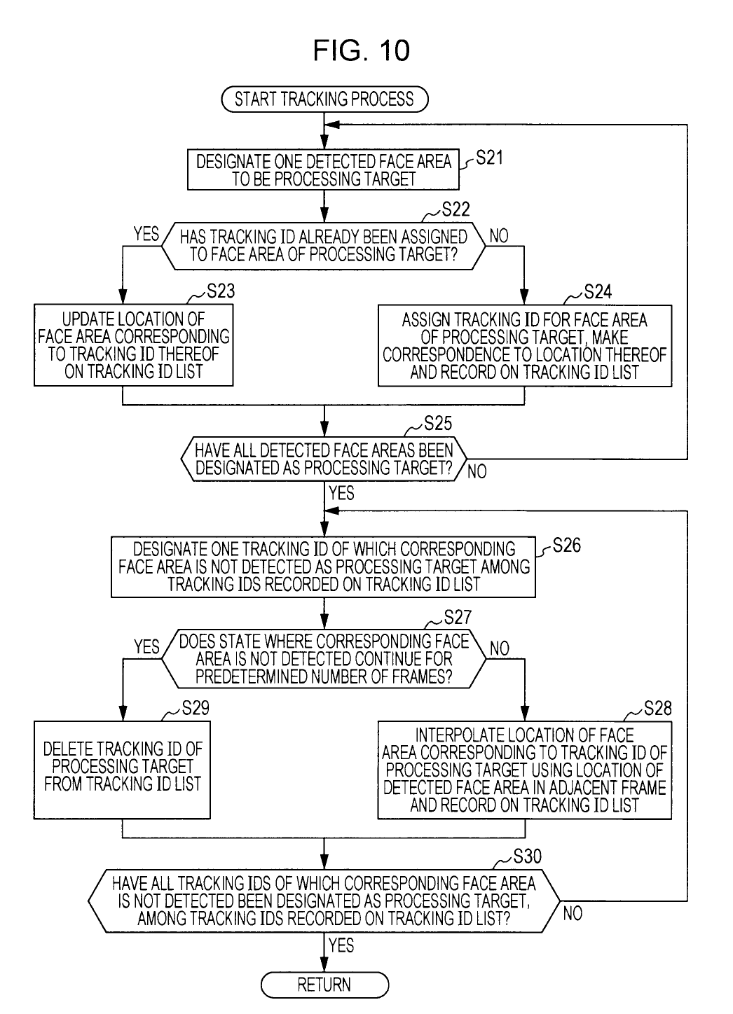

FIG. 10 is a flowchart illustrating the tracking process of Step S13 in detail. In Step S21, the tracking unit 32 designates one face area detected by the face area detection unit 31 in the process of the previous Step S12 as the processing target. However, when any of the face areas is not detected in the process of the previous Step S12, and there is no face area to be designated as the processing target, Steps S21 to S25 are skipped and the process advances to Step S26.

In Step S22, it is determined whether or not a tracking ID has already been assigned to the face area that is the processing target by the tracking unit 32. More specifically, when a difference between the location where a face area is detected in the previous frame and the location of the face area that is the processing target is within a predetermined range, the face area that is the processing target is determined to have been detected in the previous frame and already been assigned with a tracking ID. On the contrary, when a difference between the location where a face area is detected in the previous frame and the location of the face area that is the processing target is beyond a predetermined range, the face area that is the processing target is determined to be detected for the first time at this time, and not to be assigned with a tracking ID.

In Step S22, when it is determined that a tracking ID has already been assigned to the face area that is the processing target, the process advances to Step S23. In Step S23, the tracking unit 32 updates location information of the face area recorded corresponding to the tracking ID of a retained tracking ID list with location information of the face area that is the processing target. After that, the process advances to Step S25.

On the contrary, in Step S22, when it is determined that a tracking ID has not been assigned to the face area that is the processing target, the process advances to Step S24. In Step S24, the tracking unit 32 assigns a tracking ID to the face area that is the processing target, makes the assigned tracking ID correspond to the location information of the face area that is the processing target, and records the data on the tracking ID list. After that, the process advances to Step S25.

In Step S25, the tracking unit 32 verifies whether or not a face area that has not been designated as the processing target remains among all the face areas detected by the face area detection unit 31 in the process of the previous Step S12. Then, when a face area that has not been designated as the processing target remains, the process returns to Step S21 and processes thereafter are repeated. On the contrary, when a face area that has not been designated as the processing target does not remain, in other words, when all the face areas detected in the process of the previous Step S12 are designated as the processing targets, the process advances to Step S26.

In Step S26, the tracking unit 32 designates tracking IDs of which face areas are not detected in the process of the previous Step S12 as the processing target one by one among the tracking IDs recorded on the tracking ID list. Furthermore, when there is no tracking ID of which the face area is not detected in the process of the previous Step S12 and no tracking ID to be designated as the processing target among the tracking IDs recorded on the tracking ID list, Steps S26 to S30 are skipped, the tracking process ends and returns to the speech segment determination process shown in FIG. 9.

In Step S27, the tracking unit 32 determines whether or not a state where a face area corresponding to the tracking ID of the processing target is not detected continues for a predetermined number of frames or more (for example, the number of frames corresponding to a period for about two seconds). When the state is determined not to continue for the predetermined number of frames or more, the location of the face area corresponding to the tracking ID of the processing target is subjected to interpolation using location information of a face area detected in the adjacent frame (for example, using location information of a face area in one previous frame), and the tracking ID list is updated. After that, the process advances to Step S30.

On the other hand, in Step S27, when a state where a face area corresponding to the tracking ID of the processing target is not detected is determined to continue for the predetermined number of frames or more, the process advances to Step S29. In Step S29, the tracking unit 32 deletes the tracking ID of the processing target from the tracking ID list. After that, the process advances to Step 530.

In Step S30, the tracking unit 32 verifies whether or not a tracking ID that is not designated as a processing target remains among tracking IDs recorded on the tracking ID list and of which face areas are not detected in the process of the previous Step S12. Then, when the tracking ID that is not designated as a processing target remains, the process returns to Step S26, and processes thereafter are repeated. On the contrary, when a tracking ID that is not designated as a processing target does not remain, the tracking process ends and returns to the speech segment determination process shown in FIG. 9.

After the end of the tracking process described above, attention is sequentially paid to each of tracking IDs on the tracking ID list, and the process from Steps S14 to S19 to be described below is executed corresponding to each of them.

In Step S14, the face area detection unit 31 extracts face areas corresponding to the tracking IDs to which attention is paid and outputs the data to the lip area detection unit 33. The lip area detection unit 33 extracts lip areas from the face areas input from the face area detection unit 31, and outputs the data to the lip image generation unit 34. The lip image generation unit 34 generates determination target lip images based on the lip areas input from the lip area detection unit 33, and outputs the data to the time-series synthesized image generation unit 35.

In Step S15, the time-series synthesized image generation unit 35 generates time-series synthesized images based on the total 2N+1 determination target lip images including the determination target lip images corresponding to the tracking IDs to which attention is paid, and outputs the data to the feature amount calculation unit 36. Furthermore, the time-series synthesized images output here are delayed from the frame as a processing target up to Step S14 by N frames.

In Step S16, the feature amount computation unit 36 computes pixel difference feature amounts of the time-series synthesized images that are supplied from the time-series synthesized image generation unit 35 and corresponds to the tracking IDs to which attention is paid, and outputs the computation result to the speech segment classifier 20.

In Step S17, the speech segment classifier 20 computes speech scores based on the pixel difference feature amounts that are input from the feature amount computation unit 36 and corresponds to the time-series synthesized images of the tracking IDs to which attention is paid, and outputs the result to the normalization unit 37. In Step S18, the normalization unit 37 normalizes the speech scores input from the speech segment classifier 20, and outputs normalized scores obtained from the result to the speech segment determination unit 38.

In Step S19, the speech segment determination unit 38 determines whether the face areas corresponding to the tracking IDs to which attention is paid correspond to a speech segment or to a non-speech segment by comparing the normalized scores input from the normalization unit 37 to a predetermined threshold value. Furthermore, as described above, since the process from Steps S14 to S19 is executed by corresponding to each of the tracking IDs on the tracking ID list, the determination result corresponding to each of the tracking IDs on the tracking ID list is obtained from the speech segment determination unit 38.

After that, the process returns to Step S12, and a process thereafter continues until the input of the determination target moving image ends. As above, description on the speech segment determination process ends.

### [Regarding 2N+1, the Number of Face Image Frames as the Base of a Time-Series Synthesized Image]

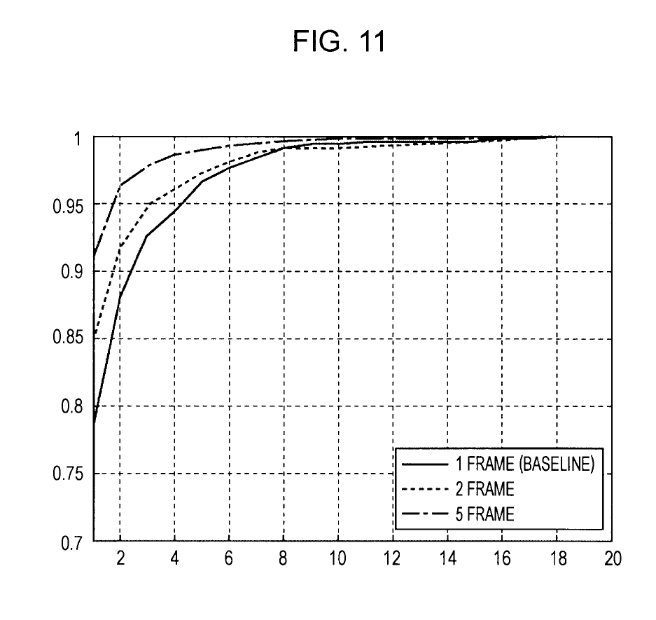

FIG. 11 is a graph showing the difference in determination performances based on 2N+1, the number of face image frames that are the base of a time-series synthesized image. The drawing shows determination accuracy when the number of face image frames that is the base of a time-series synthesized image is one (N=0), two (N=1), and five (N=2).

As shown in FIG. 11, as the number of face image frames that is the base of a time-series synthesized image increases, the determination performance improves. However, if the number of frames is high, noise can be easily included in a pixel difference feature amount in time series. Therefore, it can be said that the optimum value of N is about 2.

### [Regarding Determination Performance of Speech Segment Determining Device 30]

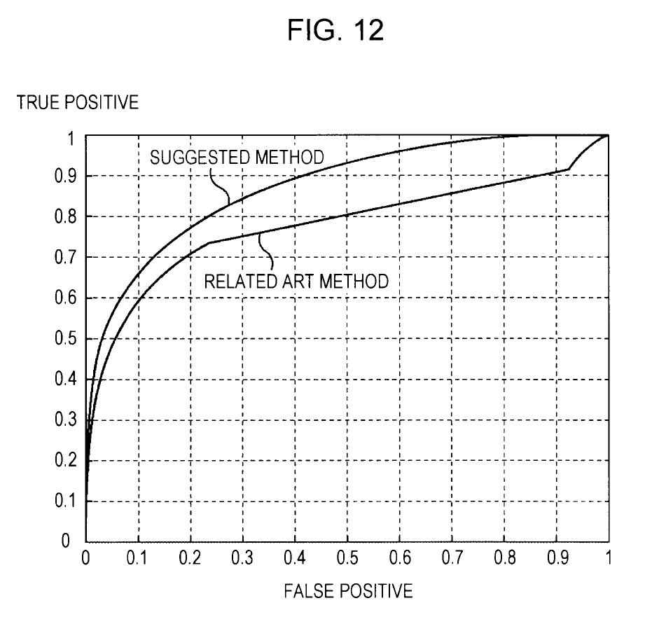

FIG. 12 shows comparison results of being affirmative or negative in determination when a speech segment in a determination target moving image (equivalent to 200 speech acts) is determined by the speech segment determining device 30 and the invention of Japanese Unexamined Patent Application Publication No. 2009-223761 described above. In the drawing, the suggested method corresponds to the speech segment determining device 30, and the related art method corresponds to the invention of Japanese Unexamined Patent Application Publication No. 2009-223761. As shown in the drawing, it is found that the speech segment determining device 30 obtains more correct determination results than the invention of Japanese Unexamined Patent Application Publication No. 2009-223761.

### [Regarding Determination Time of Speech Segment Determining Device 30]

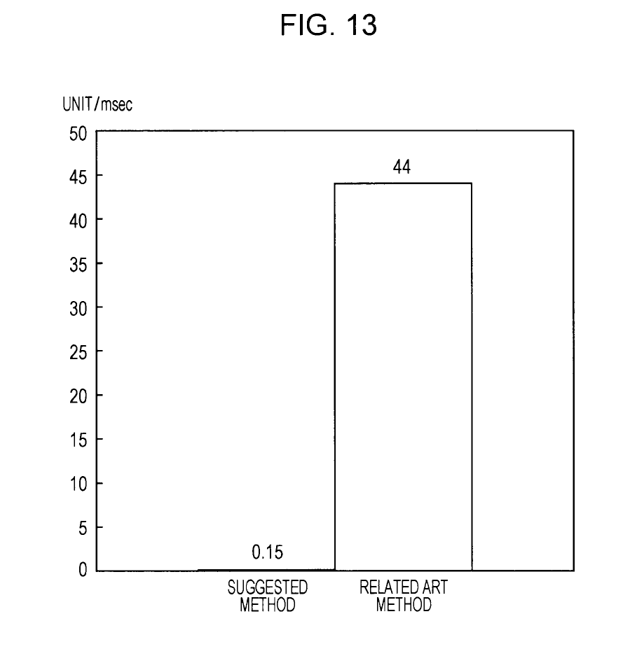

FIG. 13 shows a result of comparing times necessary for obtaining determination results between the speech segment determining device 30 and the invention of Japanese Unexamined Patent Application Publication No. 2009-223761 described above when face areas of six people are present in the same frame. In the drawing, the suggested method corresponds to the speech segment determining device 30 and the related art method corresponds to the invention of Japanese Unexamined Patent Application Publication No. 2009-223761. As shown in the drawing, it is understood that the speech segment determining device 30 can obtain a determination result for an overwhelmingly short period of time in comparison to the invention of Japanese Unexamined Patent Application Publication No. 2009-223761.

Incidentally, in the same method as the embodiment, it is possible to generate a classifier by learning, which is for discriminating, for example, whether or not a person that is the subject is walking, running, or the like, as well as whether or not it is raining in the captured background, or the like, whether or not any movement is continued on the screen.

### [Application of Pixel Difference Feature Amount of Time-Series Synthesized Image]

Furthermore, a pixel difference feature amount of a time-series synthesized image can be applied in order to learn a speech recognition classifier for recognizing speech content. More specifically, a label indicating speech content is assigned to a time-series synthesized image as learning sample data, and a speech recognition classifier is learned using the pixel difference feature amount. By using a pixel difference feature amount of a time-series synthesized image in learning, it is possible to improve the recognition performance of the speech recognition classifier.

Incidentally, the series of processes described above can be executed by hardware and by software. When a series of processes is executed by software, a program composing the software is installed from a program recording medium in computers which include dedicated hardware or, for example, general-purposed personal computers or the like that can execute various functions by installing various programs.

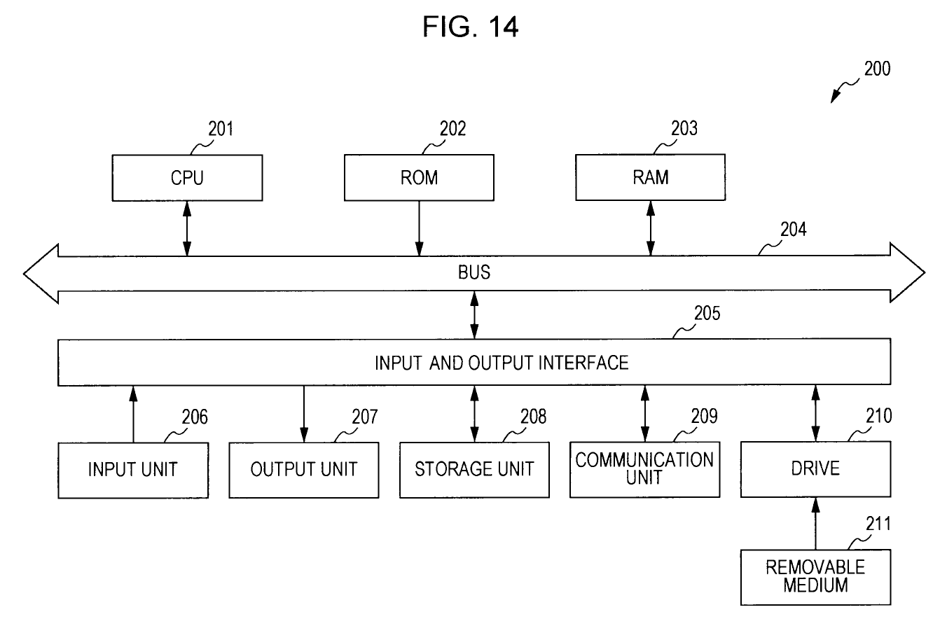

FIG. 14 is a block diagram showing a configuration example of hardware of a computer that executes the series of processes described above by a program.

In a computer 200, a CPU (Central Processing Unit) 201, a ROM (Read Only Memory) 202, and a RAM (Random Access Memory) 203 are connected to one another by a bus 204.

The bus 204 is further connected to an input/output interface 205. The input/output interface 205 is connected to an input unit 206 including a keyboard, a mouse, a microphone, or the like, an output unit 207 including a display, a speaker, or the like, a storing unit 208 including a hard disk, a non-volatile memory, or the like, a communication unit 209 including a network interface, or the like, and a drive 210 driving a removable media 211 including magnetic disks, optical discs, magneto-optical discs, semiconductor memories or the like.

The computer composed as above performs a series of processes described above such that the CPU 201 loads a program stored in the storage unit 208 in the RAM 203 through the input/output interface 205 and the bus 204 for execution.

The program executed by the computer (CPU 201) is recorded in the removable medium 211 that is a package medium composed of, for example, magnetic disks (including flexible disks), optical discs (CD-ROMs (Compact Disc-Read Only Memories), DVDs (Digital Versatile Discs), or the like), magneto-optical discs, semiconductor memories, or the like, or is supplied through a wired or wireless transmission medium such as Local Area Networks, the Internet, digital satellite broadcasting.

In addition, the program can be installed in the storage unit 208 via the input/output interface 205 by loading the removable medium 211 on the drive 210. Furthermore, the program can be received in the communication unit 209 via the wired or wireless transmission medium and installed in the storage unit 208. In addition to that, the program can be installed in advance in the ROM 202 and the storage unit 208.

Furthermore, the program that the computer executes may be one for performing processes in time series following the order described in the present specification, or may be one for performing processes in parallel or at a necessary time such as when it is called out.

In addition, the program may be processed by one computer, or may be processed by a plurality of computers in a distributed manner. Furthermore, the program may be executed by being transmitted to a remote computer.

The present application contains subject matter related to that disclosed in Japanese Priority Patent Application JP 2010-135307 filed in the Japan Patent Office on Jun. 14, 2010, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus comprising:
first generating means for generating learning images respectively corresponding to each frame of a learning moving image in which a subject conducting a predetermined movement is imaged;
first synthesizing means for generating a synthesized learning image such that one of the sequentially generated learning images is set to serve as a reference, and a plurality of the learning images corresponding to the predetermined number of frames including the learning image serving as the reference is arranged at a predetermined location and synthesized;
learning means for computing a feature amount of the generated synthesized learning image, and performing statistical learning using the feature amount obtained as the computation result to generate a classifier that discriminates whether or not an determination image that serves as a reference of an input synthesized determination image corresponds to the predetermined movement;
second generating means for generating determination images respectively corresponding to each frame of a determination moving image to be determined whether or not the image corresponds to the predetermined movement;
second synthesizing means for generating a synthesized determination image such that one of the sequentially generated determination images is set to serve as a reference, and a plurality of the determination images corresponding to a predetermined number of frames including the determination image serving as the reference is arranged at a predetermined location and synthesized;
feature amount computing means for computing a feature amount of the generated synthesized determination image; and
determining means for determining whether or not the determination image serving as the reference for the synthesized determination image corresponds to the predetermined movement based on a score as a discrimination result obtained by inputting the computed feature amount to the classifier.

2. The information processing apparatus according to claim 1, wherein the feature amount of an image is a pixel difference feature amount.

3. The information processing apparatus according to claim 2, further comprising:
normalizing means for normalizing a score as a discrimination result obtained by inputting the computed feature amount to the classifier,
wherein the determining means determines whether or not the determination image serving as the reference for the synthesized determination image corresponds to the predetermined movement based on the normalized score.

4. The information processing apparatus according to claim 2,
wherein the predetermined movement is speech of a person who is a subject, and
wherein the determining means determines whether or not the determination image serving as the reference for the synthesized determination image corresponds to a speech segment based on a score as a discrimination result obtained by inputting the computed feature amount to the classifier.

5. The information processing apparatus according to claim 4,
wherein the first generating means detects the face area of a person from each frame of the learning moving image in which the person speaking is imaged as a subject, detects the lip area from the detected face area, and generates a lip image as the learning image based on the detected lip area, and
wherein the second generating means detects the face area of a person from each frame of the determination moving image, detects the lip area from the detected face area, and generates a lip image as the determination image based on the detected lip area.

6. The information processing apparatus according to claim 5, wherein, when the face area is not detected from a frame to be processed in the determination moving image, the second generating means generates the lip image as the determination image based on location information of a face area detected in the previous frame.

7. The information processing apparatus according to claim 2,
wherein the predetermined movement is speech of a person who is a subject, and
wherein the determining means determines speech content corresponding to the determination image serving as the reference for the synthesized determination image based on a score as a discrimination result obtained by inputting the computed feature amount to the classifier.

8. An information processing method performed by an information processing apparatus identifying an input moving image comprising the steps of:
firstly generating learning images respectively corresponding to each frame of a learning moving image in which a subject conducting a predetermined movement is imaged;
firstly synthesizing to generate a synthesized learning image such that one of the sequentially generated learning images is set to serve as a reference, and a plurality of the learning images corresponding to the predetermined number of frames including the learning image serving as the reference is arranged at a predetermined location and synthesized;
learning to compute a feature amount of the generated synthesized learning image, and perform statistical learning using the feature amount obtained as the computation result so as to generate a classifier that discriminates whether or not an determination image that serves as a reference of an input synthesized determination image corresponds to the predetermined movement;
secondly generating determination images respectively corresponding to each frame of a determination moving image to be determined whether or not the image corresponds to the predetermined movement;
secondly synthesizing to generate a synthesized determination image such that one of the sequentially generated determination images is set to serve as a reference, and a plurality of the determination images corresponding to a predetermined number of frames including the determination image serving as the reference is arranged at a predetermined location and synthesized;
computing a feature amount of the generated synthesized determination image; and
determining whether or not the determination image serving as the reference for the synthesized determination image corresponds to the predetermined movement based on a score as a discrimination result obtained by inputting the computed feature amount to the classifier.

9. A program which causes a computer to function as:
first generating means for generating learning images respectively corresponding to each frame of a learning moving image in which a subject conducting a predetermined movement is imaged;
first synthesizing means for generating a synthesized learning image such that one of the sequentially generated learning images is set to serve as a reference, and a plurality of the learning images corresponding to the predetermined number of frames including the learning image serving as the reference is arranged at a predetermined location and synthesized;
learning means for computing a feature amount of the generated synthesized learning image, and performing statistical learning using the feature amount obtained as the computation result to generate a classifier that discriminates whether or not an determination image that serves as a reference of an input synthesized determination image corresponds to the predetermined movement;
second generating means for generating determination images respectively corresponding to each frame of a determination moving image to be determined whether or not the image corresponds to the predetermined movement;
second synthesizing means for generating a synthesized determination image such that one of the sequentially generated determination images is set to serve as a reference, and a plurality of the determination images corresponding to a predetermined number of frames including the determination image serving as the reference is arranged at a predetermined location and synthesized;
feature amount computing means for computing a feature amount of the generated synthesized determination image; and
determining means for determining whether or not the determination image serving as the reference for the synthesized determination image corresponds to the predetermined movement based on a score as a discrimination result obtained by inputting the computed feature amount to the classifier.

10. An information processing apparatus comprising:
a first generation unit that generates learning images respectively corresponding to each frame of a learning moving image in which a subject conducting a predetermined movement is imaged;
a first synthesis unit that generates a synthesized learning image such that one of the sequentially generated learning images is set to serve as a reference, a plurality of the learning images corresponding to the predetermined number of frames including the learning image serving as the reference is arranged at a predetermined location and synthesized;
a learning unit that computes a feature amount of the generated synthesized learning image, and performs statistical learning using the feature amount obtained as the computation result to generate a classifier that discriminates whether or not an determination image that serves as a reference of an input synthesized determination image corresponds to the predetermined movement;
a second generation unit that generates determination images respectively corresponding to each frame of a determination moving image to be determined whether or not the image corresponds to the predetermined movement;
a second synthesis unit that generates a synthesized determination image such that one of the sequentially generated determination images is set to serve as a reference, and a plurality of the determination images corresponding to a predetermined number of frames including the determination image serving as the reference is arranged at a predetermined location and synthesized;
a feature amount computation unit that computes a feature amount of the generated synthesized determination image; and
a determination unit that determines whether or not the determination image serving as the reference for the synthesized determination image corresponds to the predetermined movement based on a score as a discrimination result obtained by inputting the computed feature amount to the classifier.
